(19) United States
(12) Patent Application Publication
(10) Pub. No.: US 2010/0046388 A1
(43) Pub. Date: Feb. 25, 2010

(54) METHOD AND SYSTEM FOR ESTIMATING DISTANCE BETWEEN NODES IN WIRELESS SENSOR NETWORKS

(75) Inventors: Ki Seon KIM, Gwangju (KR); Eun Chan KIM, Gwangju (KR); Seok WOO, Gwangju (KR); In Soo KOO, Ulsan (KR)

Correspondence Address: AMPACC Law Group, 3500 188th Street S.W., SUITE 103, Lynnwood, WA, 98037, US

(73) Assignee: Gwangju Institute of Science and Technology, Gwangju (KR)

(21) Appl. No.: 12/533,256

(22) Filed: Jul. 31, 2009

(30) Foreign Application Priority Data
Aug. 19, 2008 (KR) 10-2008-0080864

(51) Int. Cl. H04L 12/26; H04L 12/413

(52) U.S. Cl. 370/252; 370/445

(57) ABSTRACT

The present invention relates to a method for estimating a distance between nodes by using a round trip time (RTT) of a packet based on a CSMA/CA protocol in wireless sensor networks and a system thereof. The present invention provides a method for estimating a distance between nodes in wireless sensor networks that includes (a) measuring a transmission time of a transmission signal transmitted to the other node and a reception time of a reception signal received from the other node in response the transmission signal, and receiving a reception time of the transmission signal through the reception signal from the other node and a transmission time of the reception signal through a signal received after the reception signal from the other node; and (b) estimating a distance to the other node by using the transmission/reception time of all signals acquired in step (a). According to the present invention, it is possible to accurately estimate the distance between two nodes and as a result, it is possible to accurately identify positions of nodes that are deployed in a sensor field.

### BACKGROUND OF THE INVENTION

1. Field of the Invention

The present invention relates to a method and a system for estimating a distance between two nodes in wireless sensor networks. More particularly, the present invention relates to a method and a system for estimating a distance between nodes relevant to a technology for a physical distance between two nodes by measuring a round trip time (RTT) of a packet based on a carrier sense multiple access with collision avoidance (CSMA/CA) protocol in wireless networks.

2. Description of the Related Art

Wireless sensor networks (WSNs) are composed of many sensor nodes having low price, high power efficiency, self-organization and a short communication distance. Accordingly, WSNs can be applied to various practical and commercial services such as target tracking systems, surveillance to monitor dangerous, confidential or disaster areas, and so on.

One of essential functions in WSNs is a function of estimating the position of each node because the reported data forwarded by multi-nodes become useless without the position of each node. Although a well-known positioning method may use global positioning systems (GPS), a GPS receiver is a large burden for nodes requiring a small size and low power consumption. In addition, GPS cannot be used in indoor positioning environments.

Consequently, many methods to estimate the position of each node based on the distance between the nodes in WSNs have been studied. In these cases, it is essential to estimate a high accurate distance between the nodes.

To obtain the distance between the nodes, there are three basic measurement techniques. A technique of received signal strength (RSS) uses the attenuation between the transmitted signal strength and the received signal strength. Techniques of a time of arrival (TOA) and a time difference of arrival (TDOA) basically use a time of flight (TOF) of a packet from a transmitting node to a receiving node. The performance of the TOA or TDOA technique depends on the accuracy of time measurement.

As one example of the method of measuring the distance between the nodes using the RTT, the Korean Unexamined Patent Publication No. 10-2002-0026562 (published in Apr. 10, 2002) discloses the method to obtain the distance between the nodes by calculating the TOA based on the carrier sense multiple access with collision avoidance (CSMA/CA) protocol, where Node A transmits a request to send (RTS) packet and then Node B replies to Node A by transmitting a clear to send (CTS) packet.

While handshaking RTS-CTS packets, Node A measures a handshaking time taken from the moment of transmitting the RTS packet to the moment of receiving the CTS packet and Node B measures a processing delay from the moment of receiving the RTS packet to the moment of transmitting the CTS packet.

The CTS packet includes the processing delay time to let Node A know. After receiving the CTS packet, Node A can obtain an actual RTT between Node A and Node B by subtracting the processing delay time from the handshaking time. Finally based on the actual RTT, Node A can estimate the distance between Node A and Node B.

To acquire a more accurate measurement value, the unexamined patent publication discloses a method to compensate with a system delay time generated during transmitting and receiving the packet and a signal matched filter in a spreading code mechanism.

However, the processing delay time in the CTS packet can be calculated at the time after transmission of the CTS packet begins. In other words, it must finish calculating the processing delay time and saving the processing delay time in the CTS packet, from the moment of transmitting the CTS packet to the moment of transmitting the processing delay time saved in the CTS packet. However, as a transmission speed increases, it becomes hard to finish the calculating and saving the processing delay time (hereinafter calculate and save are referred to as ‘measure’) within the given time. Therefore, a possibility that the packet will be damaged increases because of not enough time to modify the transmitting packet. In some cases, the packet may be difficult to modify.

In particular, in the case when the system performance of the nodes in WSNs is restricted, the probability to damage the packet becomes high. In addition, a large error is generated in the method of estimating the distance using RTT because the transmission time and the reception time of a packet cannot accurately measured.

FIG. 1 is a diagram illustrating causes of errors generated while a transmission time and a reception time are measured at the moment of transmitting a packet at a transmission node (110) and at the moment of receiving the packet to a reception node (120), respectively. At the transmission node 110 in FIG. 1, (G), (E), and (D) denote a moment to attempt to occupy a wireless channel, a moment to measure the transmission time at a timer of the transmission node, and a moment to actually start transmitting a packet, respectively. At the reception node 120 in FIG. 1, (A) and (B) denote a moment to start receiving the packet and a moment to measure the reception time at a timer of the reception node, respectively. In CSMA/CA protocol, there is uncertain delay called a random-backoff time to access a wireless channel to avoid collision.

In FIG. 1, the main causes to give rise to errors in time measurement are as followings; (F) depicts the uncertain delay called a random-backoff time in CSMA/CA protocol to avoid collision in access to a wireless channel, (C) depicts a processing delay from sensing a received packet to measure the actual time at a timer, such as interrupt latency, processing time to calculate and to save the actual time, etc. Depending on a clock frequency, a resolution of a timer is also important for reducing errors in time measurement.

### SUMMARY OF THE INVENTION

To solve the above-mentioned problem, an object of the present invention is to provide a method and a system for estimating a distance between nodes in WSNs by measuring an actual time when it is detected that packets are transmitted and received from communication with the other node, and by providing the actual time which is included in the packets in follow-up communication.

In order to achieve the above-mentioned object, there is provided a method for estimating a distance between two nodes in WSNs that includes (a) a step to measure a transmission time and a reception time at both nodes and to transfer the transmission time (or the reception time) to the other node at the next communication; and (b) a step to estimate a distance between the nodes by using the transmission time and the reception time acquired in step (a).

Preferably, two nodes communicate with each other by exchanging at least two signals, such as ‘a notification signal’ transmitted to the other node for inquiring or providing possessed data and ‘a response signal’ responding to the notification signal.

Preferably, step (a) includes (aa) measuring a transmission time of the notification signal or a reception time of the response signal at one node, and receiving a reception time of the notification signal through the response signal and a transmission time of the response signal through a signal received after the response signal from the other node; or (aa′) measuring a reception time of the notification signal or a transmission time of the response signal, and receiving the transmission time of the notification signal or the reception time of the response signal from the other node through the signal received after the notification signal.

Preferably, step (a) is repeated at twice to N times to the maximum within a predetermined assigned time so that two nodes exchange data with each other.

Preferably, step (b) includes (ba) calculating a propagation delay to the other node by using the transmission/reception time of all the signals acquired in step (a); and (bb) estimating a distance to the other node by using the calculated propagation delay.

There is provided a system for estimating a distance between nodes in WSNs that includes a sensing node that measures a transmission time of a transmission signal transmitted to the other node and a reception time of a reception signal received from the other node in response to the transmission signal, and receives a reception time of the transmission signal through the reception signal and a transmission time of the reception signal through a signal received after the reception signal from the other node.

Preferably, the sensing node is a node for inquiring or providing possessed data or for being inquired or receiving the data.

Preferably, the sensing node calculates a propagation delay to the other node by using the transmission/reception time of all the acquired signals and estimates a distance to the other node by using the calculated propagation delay.

Preferably, the sensing node includes a time measurement unit that measures the transmission time of the transmission signal transmitted to the other node and the reception time of the reception signal received from the other node in response to the transmission signal; and a distance estimation unit that estimates the distance to the other node by using the received times and the times measured by the time measurement unit when receiving the reception time of the transmission signal and the transmission time of the reception signal from the reception signal or the signal received after the reception signal.

According to the present invention, it is possible to acquire the following effects by recording a time when it is detected that packets are transmitted and received from communication with the other node and providing the recorded time that is included in the packets in follow-up communication. First, the node can accurately measure a round trip time of the packets. Accordingly, it is possible to accurately estimate a distance from the other node. Furthermore, it is possible to accurately obtain positions of nodes that are deployed in a sensor field. Second, packets that are transmitted to the other node need not to be modified and an accurate packet transmitting/receiving time can be provided to the other node. Third, since a GPS needs not to be used, it is possible to save cost and easily applied to an indoor positioning system to identify predetermined targets.

Further, it is possible to easily improve the accuracy in a transmission/reception time of a packet by using a counter having a rapid response speed and a clock having a high frequency.

### BRIEF DESCRIPTION OF THE DRAWINGS

FIG. 1 is a timing diagram illustrating causes of errors generated while a transmission time and a reception time are measured at the time of transmitting a packet from a transmission node to a reception node in wireless networks;

FIG. 2 is a schematic conceptual diagram illustrating a configuration of a wireless sensor network system according to a preferred embodiment of the present invention;

FIG. 3 is a schematic block diagram illustrating an internal configuration of a sensor node that is provided in a wireless sensor network system according to a preferred embodiment of the present invention;

FIG. 4 is a flowchart illustrating a method for estimating a distance between two sensor nodes according to a preferred embodiment of the present invention;

FIG. 5 is a flowchart illustrating an intercommunication process for estimating a distance between a first sensor node and a second sensor node according to a preferred embodiment of the present invention;

FIGS. 6 and 7 are conceptual diagrams for illustrating driving of a control unit of a sensor node according to a preferred embodiment of the present invention; and

FIG. 8 is a timing diagram for illustrating a transmission time and a reception time of a packet according to the present invention.

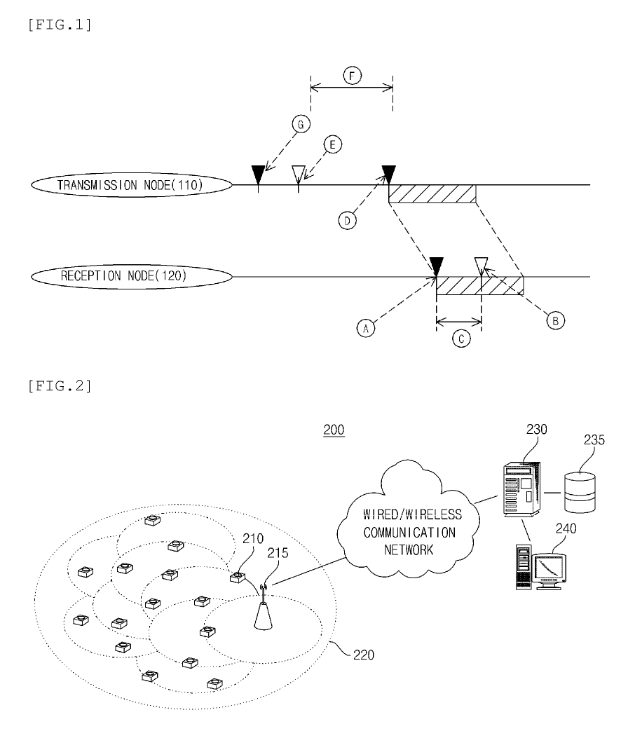

### DETAILED DESCRIPTION OF THE PREFERRED EMBODIMENTS

Hereinafter, preferred embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the preferred embodiment of the present invention will be described, but it will be understood to those skilled in the art that the spirit and scope of the present invention are not limited thereto and various modifications and changes can be made.

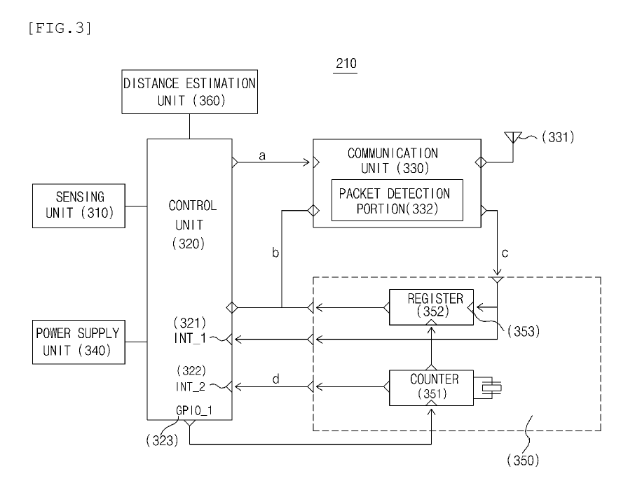

FIG. 2 is a schematic conceptual diagram illustrating a configuration of a wireless sensor network system according to a preferred embodiment of the present invention. As shown in FIG. 2, the wireless sensor network system 200 according to a preferred embodiment of the present invention includes two or more sensor nodes 210, a sink node 215, a sensing data administration server 230, a sensing data administration database 235, and an observer terminal 240.

In the wireless sensor network system 200, when the sensor nodes 210 that are distributed in a sensor field 220 sense predetermined data, the sink node 215 collects the predetermined data through a predetermined path and transfers the data to the sensing data administration server 230 through a wired/wireless communication network. The sensing data administration server 230 determines whether or not an error occurs in the sensor field 220 by using the data and stores the relevant data in the sensing data administration database 235. In this case, an observer can access the sensing data administration server 230 through the observer terminal 240 to check it and take an appropriate action. Alternately, the observer receives the related data in the observer terminal 240 by the sensing data administration server 230 to take the appropriate action on the basis of the relevant data.

Referring to such a series of processes, in the case that the sensor field 220 is a battled field, the sensing data may be data on whether a predetermined target is our forces or the enemy force and the sensing data administration server 230 or the observer terminal 240 can grasp a moving situation of the enemy force on the basis of the data. Meanwhile, the sink node 215 can directly transfer the sensing data to the observer terminal 240 through the wired/wireless communication network. In this case, it is preferable that the sink node 215 or the observer terminal 240 processes the sensing data so that the observer can understand data displayed on a display apparatus.

The sensor node 210, as a sensing device that is applied with computing power, represents an intelligent communication device constituting the wireless sensor network. In the embodiment of the present invention, the sensor node 210 serves to collect physical situation data and transfer real-time situation detection information, that is, the sensing data to the sink node 215 by using the wireless communication in response to a situation change. Herein, the wireless communication is general RF communication and may include Zigbee, Bluetooth, WiFi, etc.

The sensor node 210 may be provided with a sensor, a local storage module, a communication module, a processor, a battery, etc. For example, the sensor node 210 can be configured as shown in “Routing Techniques in Wireless Sensor Networks: A survey” published in ‘IEEE Wireless Communications 11, 6-28’ by Jamal N. Al-Karaki and Ahmed E. Kamal in 2004. Hereinafter, the internal configuration of the sensor node 210 will be described in more detail with reference to FIG. 3.

It is preferable that the sensor node 210 solves collision, overhearing, control packet overhead, idle listening, etc. which are causes for energy waste in the embodiment of the present invention. The reason for this will be described below. In the above description, the collision represents a case in which packet information cannot be used due to damage of the packet information in packet collision. In this case, the sensor node 210 must retransmit the packet containing the information. The overhearing represents a case in which the sensor node 210 receives the packet even though a destination is not the sensor node 210 but the other node. In this case, the sensor node 210 must transmit the received packet to the node corresponding to the destination. The control packet overhead represents a case in which the sensor node 210 transmits packets that need not to be transmitted, such as network control packet other than the acquired sensing information. The idle listening represents a case in which the sensor node 210 continuously maintains a standby state without entering a sleep state since the sensor node 210 does not know when receiving the data from the other node.

In the embodiment of the present invention, the sink node 215 serves as a gateway that collects the sensing data of the sensor node 210 and transfers the sensing data to the sensing data administration server 230 through the wired/wireless communication network. Herein, the wired/wireless communication network, as a communication network that connects the sink node 215 and the sensing data administration server 230 to each other, is constituted by an Internet network or a mobile communication network (i.e., CDMA network) in the embodiment of the present invention. However, the wired/wireless communication network needs not to be limited thereto and may be constituted by a GPS network, a wireless personal area network (WPAN), or the like.

The sink node 215 has an entire configuration similar to the sensor node 210, but the sink node 215 is different from the sensor node 210 in that the sink node 215 does not perform a sensing function and can receive energy without limit. By the above-description, the sink node 215 may be substituted by a base station in the embodiment of the present invention. The base station represents a mobile or stationary wireless station. In the embodiment of the present invention, it is preferable that the sink node 215 can be substituted by the base station particularly when the wired/wireless communication network is constituted by the mobile communication network.

The sensing data administration server 230 is a server that serves to receive the sensing data from the sink node 215 and process the sensing data. In the embodiment of the present invention, the sensing data administration server 230 serves to determine whether or not an error occurs in the sensor field 220 on the basis of the sensing data and record the determination result in the sensing data administration database 235 or provides the determination result to the observer terminal 240.

The sensing data administration database 235 provides a database that stores data generated by the sensing data administration server 230 or contain various information. The sensing data administration database 235 stores the sensing data and an analysis/determination result value of the sensing data administration server 230 in the embodiment of the present invention.

The observer terminal 240 is a terminal that is accessed by a person who installs the sensor node 210 in the sensor field 220 or a person who requests a result value of the sensing data. The observer terminal 240 serves to display the result value or request the result value to the sensing data administration server 230 in the embodiment of the present invention. Meanwhile, in the present invention, when the sensing data administration server 230 receives an access request from the observer terminal 240, the sensing data administration server 230 preferably authenticates the observer terminal 240 (that is, the sensing data administration server 230 determines whether or not a person who requests the access through the observer terminal 240 is authenticated). This is to improve the security of the sensing data or the result value thereof.

Meanwhile, the wireless sensor network system 200 may further include an administrator terminal. The administrator terminal, as a terminal that an administrator who takes charge of operating the sensing data administration server 230 accesses, serves to check whether or not the sensing data administration server 230 is normally operated by accessing the sensing data administration server 230 in the embodiment of the present invention.

As described above, by considering the function of the wireless sensor network system 200, the sensor node 210 according to the present invention serves to measure the transmission time and the reception time of each packet and calculate the distance between the other sensor node and the this sensor node by using a transmission time of a packet transferred from the other sensor node and the reception time of the packet. Hereinafter, the sensor node 210 will be described in more detail.

FIG. 3 is a schematic block diagram illustrating an internal configuration of a sensor node that is provided in a wireless sensor network system according to a preferred embodiment of the present invention. As shown in FIG. 3, the sensor node 210 according to a preferred embodiment of the present invention includes a sensing unit 310, a control unit 320, a communication unit 330, a power supply unit 340, a time measurement unit 350, and a distance estimation unit 360.

The sensing unit 310 serves to detect various events that occur at a location where the sensing unit 310 is installed. The sensing unit 310 includes one or more sensors.

The control unit 320 serves to control (operation processing) an entire operation of the sensor node 210. It is preferable that the control unit 320 is implemented by a subminiature/low-power micro controller unit (MCU) in the embodiment of the present invention. In this case, a CPU, a program memory, an SRAM, an EEPROM, an ADC, etc. may be integrated in the MCU and examples thereof include ATMega128L of the Atmel, MSP430 of the TI, PIC18F of the Microchip, etc. Meanwhile, the control unit 320 includes an A/D converter to convert an analog signal detected by the sensing unit 310 into a digital signal.

The communication unit 330 is provided with an antenna 331 and serves to transmit the packet containing the sensing data (or event) to the outside and receive the packet transmitted from the other sensor node 210. The communication unit 330 is provided with a packet detection portion 332 that detects the transmitted and received packets in the embodiment of the present invention.

The power supply unit 340 serves to supply the energy to the units that constitute the sensor node 210 so that the sensor node 210 can be smoothly driven. The power supply unit 340 can be implemented by using a power generator which is a battery, for example.

The time measurement unit 350 serves to measure transmission/reception time of a packet in cooperation with the communication unit 330. The time measurement unit 350 can be implemented by a timer to measure a time at the moment that an event occurs. More particularly, the time measurement unit 350 can include a counter 351 that has time resolution so as to measure a round trip time (RTT) and a register 352 that can store counting values of the counter 351 when the communication unit 330 detects transmission or reception of the packets. In the embodiment of the present invention, the control unit 320 takes charge of measuring the transmission/reception time of the packet with the time measurement unit 350. For this, the control unit 320 also takes parts in preparation and transmission/reception of the packet.

When the time measurement unit 350 is implemented by the counter 351 and the register 352, the time measurement unit 350 operates as follows in the embodiment of the present invention. First, the control unit 320 controls an operation of the communication unit 330 by using a control signal (a) and exchanges the packet transmission/reception data with the communication unit 330 through a data bus (b). Further, the control unit 320 reads time information from the time measurement unit 350. The packet detection portion 332 monitors a predetermined pattern (i.e., preamble of the packet or packet start indicator) in a packet header when the communication unit 330 transmits or receives the packets. When the packet detection portion 332 detects the predetermined pattern, the packet detection portion 332 applies a packet transmission/reception detection signal (c) to an INT_1 321 which is an external interrupt input terminal of the control unit 320 and an Enable 353 of the register 352 without delay. The register 352 reads a current counting value from the counter 351 and stores the value on the basis of the applied signal (c). Thereafter, the control unit 320 reads the value stored in the register 352 and calculates a generation time of the applied signal (c).

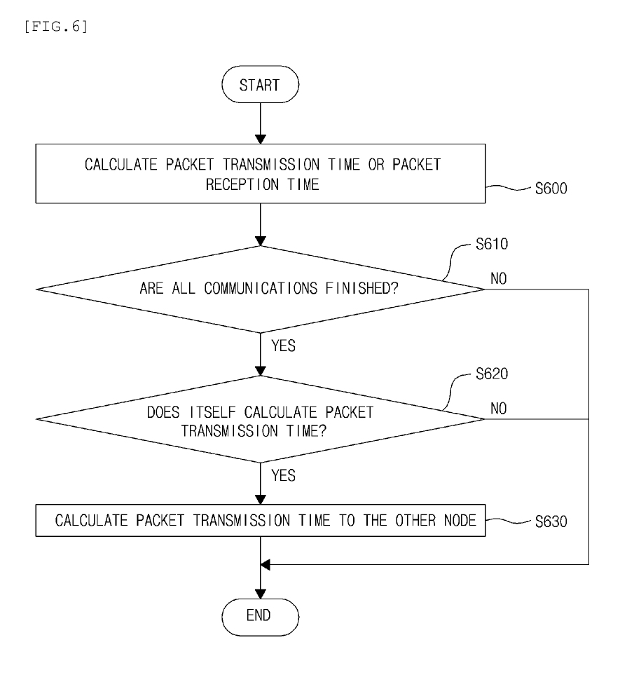

FIG. 6 illustrates an interrupt handler of an INT_1 321 that is provided in a control unit 320. Particularly, FIG. 6 illustrates an operation of the control unit 320 when the communication unit 330 applies the packet transmission/reception detection signal (c) to the control unit 320.

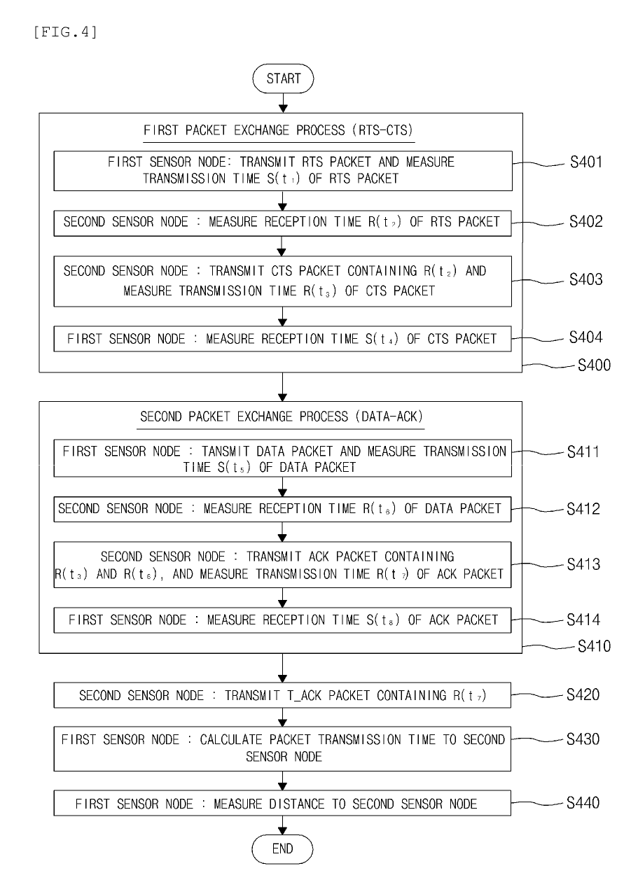

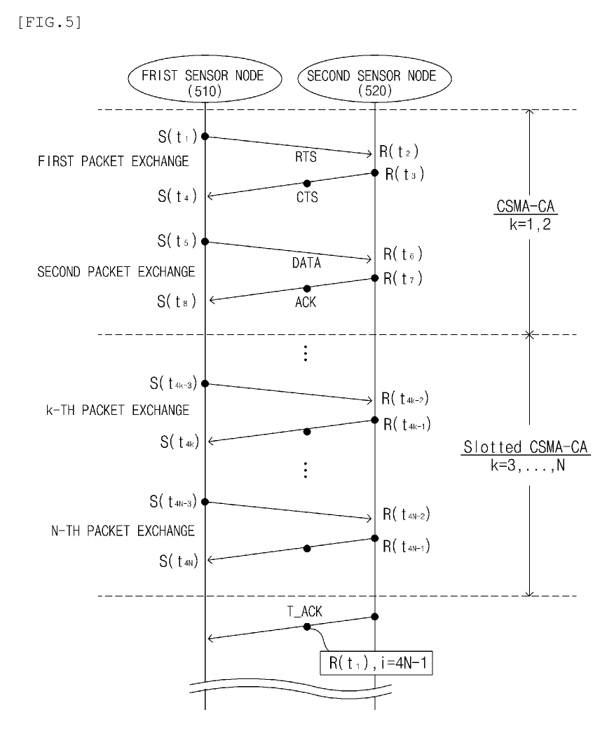

As described above, when the register 352 stores the counting value, the control unit 320 calculates the generation time of the applied signal (c), that is, a packet transmission time (or a packet reception time) (S600). The calculated time can be acquired by adding up “msec_unit+1000×{sec_unit+60×(min_unit+60×hour_unit)} of the control unit 320 and the counting value stored in the register 352. Thereafter, the control unit 320 verifies whether all communications are finished (S610) and determines whether or not the control unit 320 calculates a packet propagation delay Δt when all the communications are finished (S620). If the control unit 320 must calculates the packet propagation delay, the control unit 320 calculates the packet propagation delay to the other sensor node by using Equation 2 and Equation 3 (S630). The packet propagation delay Δt, Equation 2, and Equation 3 will now be described in detail with reference to FIGS. 4 and 5.

The counter 351 is a device composed of multiple flip-flops and has a simple function and a low price. In addition, since the counter 351 is constituted by only hardware (H/W), the counter 351 has an advantage of having a very rapid operation reaction speed. Further, when an overflow automatically occurs in the counter 351 after a predetermined cycle elapses, the counter 351 applies a signal relating to the fact to an INT_2 322 which is an external interrupt input of the control unit 320, such that the control unit 320 can update internal time information and reset the counter 351 through a GPIO_1 323.

As such, even the sensor node 210 in which the system performance is limited has a very small burden applied from the time measurement unit 350. In addition, it is possible to reduce a load of the node with respect to detailed time measurement.

FIG. 7 illustrates an interrupt handler of an INT_2 322 that is provided in a control unit 320. Particularly, FIG. 7 illustrates an operation of the control unit 320 when an overflow signal is applied from the counter 351. In the embodiment of the present invention, the counter 351 applies the overflow signal to the INT_2 322 with a cycle of 1 ms and the cycle of the signal applied to the INT_2 232 may depend on the used counter 351 and a used clock frequency.

First, the control unit 320 commands the counter 351 to operate again depending on the signal inputted into the INT_2 232 in a unit of 1 msec (S700). Thereafter, the control unit increases a variable ‘msec_unit’ and determines whether or not the variable ‘msec_unit’ is 1000 (S710). If the variable ‘msec_unit’ is not 1000, the process is terminated, while if the variable ‘msec_unit’ is 1000, the variable ‘msec_unit’ is set to 0 and a variable ‘sec_unit’ storing a second is increased. Thereafter, the control unit 320 determines whether or not the variable ‘sec_unit’ is 60 (S720). If the variable ‘sec_unit’ is not 60, the process is terminated, while if the variable ‘sec_unit’ is 60, the variable ‘sec_unit’ is set to 0 and a variable ‘min_unit’ storing a minute is increased. Thereafter, the control unit 320 determines whether or not the variable ‘min_unit’ is 60 (S730). If the variable ‘min_unit’ is not 60, the process is terminated, while if the variable ‘min_unit’ is 60, the variable ‘min_unit’ is set to 0 and a variable ‘hour_unit’ storing a hour is increased. Thereafter, when the variable ‘hour_unit’ reaches 24, the variable ‘hour_unit’ is initialized to 0 (S740).

According to the above configuration, when the counter 351 takes charge of precise time measurement of 1 msec or less and the controller 320 administrates time measurement of 1 msec or more, an interrupt occurrence frequency can remarkably reduced and a load applied to the control unit 320 can be drastically reduced.

Referring back to FIG. 3, the present invention will be described.

The distance estimation unit 360 serves to estimate the distance from the sensor node by using the transmission time of the packet transferred from the other sensor node and the reception time of the packet measured by the time measurement unit 350. A distance estimation method of the distance estimation unit 360 will be described in detail with reference to FIG. 3. Herein, the distance estimation method will not be described.

Meanwhile, the sensor node 210 may further include a storage unit to store sensing data or sensor data. The sensing data means an event which is situation information measured by the sensing unit 310 and may be expressed as measurement values of temperature, humidity, vibration, etc. In addition, the sensor data means information on the sensor node 210 itself, i.e., a node name, ID, a position, a network address, etc. The sensor data is more preferably stored in a sensing information administration database 235 by considering a memory limit of the sensor node 210.

Next, a method in which the sensor node (hereinafter, referred to as ‘first sensor node’) according to the present invention estimates the distance between two sensor nodes by exchanging the packet with the other sensor node (hereinafter, referred to as ‘second sensor node’) will be described. FIG. 4 is a flowchart illustrating a method for estimating a distance between two sensor nodes according to a preferred embodiment of the present invention. FIG. 5 is a flowchart illustrating an intercommunication process for estimating a distance between a first sensor node and a second sensor node according to a preferred embodiment of the present invention.

In conventional CSMA/CA protocol, it takes large uncertain delay from attempt to occupy a wireless channel to actual access to a wireless channel to transmit data. Therefore, it has a large error to measure the transmission time when a packet is prepared because of such an uncertain delay. It is preferable to measure the transmission time when the packet transmission is detected.

For high accurate measurement, therefore, the present invention includes a method of acquiring the transmission or reception time of a packet by using the communication unit 330, the time measurement unit 350, and the control unit 320 of FIG. 3 when the communication unit 330 detects transmission or reception of the packet. To provide the transmission time or reception time to the other node, the present invention provides a method using a follow-up packet that includes the transmission time or the reception time acquired at this time. Hereinafter, the present invention will be described in detail with reference to FIGS. 4 and 5.

In general, in the case of a carrier sense multiple access with collision avoidance (CSMA/CA) protocol, the packets are exchanged in the order of (RTS-CTS)-(DATA-ACK). In a first packet exchange process (RTS-CTS) (S400), the first sensor node 510 transmits a request to send (RTS) packet to the second sensor node 520 through the communication unit 330 and measures a transmission time S(t₁) of the RTS packet by using time measurement unit 350 and control unit 320 (S401). Thereafter, the second sensor node 520 measures and records a reception time R(t₂) of the RTS packet by using the time measurement unit 350 and control unit 320 (S402). Thereafter, the second sensor node 520 transmits a clear to send (CTS) packet containing R(t₂) in response to the RTS packet to the first sensor node 510 and measures a transmission time R(t₃) of the CTS packet by using the time measurement unit 350 and control unit 320 (S403). The first sensor node 510 measures a reception time S(t₄) of the CTS packet (S404). Through steps S401 to S404, the first sensor node can obtain S(t₁), R(t₂), and S(t₄). The distance estimation unit 360 needs a packet propagation delay Δt in order to calculate a distance between two sensor nodes 510 and 520. To acquire the packet propagation delay, the first sensor node 510 can obtain R(t₃) through a second packet exchange process (DATA-ACK) (S410). Particularly, when the second sensor node 520 transmits an acknowledgement packet (ACK) in response to a DATA packet, the second sensor node transmits a reception time R(t₃) that is included in the ACK packet.

Detailed steps constituting the second packet exchange process will be described below. First, the first sensor node 510 transmits the DATA packet and measures a transmission time S(t₅) of the DATA packet (S411). The second sensor node 520 measures a reception time R(t₆) of the DATA packet (S412). Thereafter, the second sensor node transmits the ACK packet containing R(t₃) and R(t₆), and measures a transmission time R(t₇) of the ACK packet (S413). Thereafter, the first sensor node 510 measures a reception time S(t₈) of the ACK packet (S414).

However, the transmission time R(t₇) of the ACK packet is also needed for the first sensor node in estimating a distance between two sensor nodes 510 and 520. Therefore, in the embodiment of the present invention, the second sensor node 520 transmits a T_ACK packet containing information on R(t₇) after the second packet exchange process (S420). Accordingly, the first sensor node 510 can more accurately measure the distance between two sensor nodes 510 and 520 by securing even S(t₅), R(t₆), R(t₇), and S(t₈).

In the case of a slotted CSMA/CA protocol, a total time when two sensor nodes 510 and 520 can exchange the packet with each other is constantly assigned. As a result, much time may be left even after the second sensor node 520 transmits the ACK packet. Accordingly, in the embodiment of the present invention, in order to improve the accuracy of the packet propagation delay Δt, it is preferable that the packets are continuously exchanged during the left time.

After step S420, the distance estimation unit 360 of the first sensor node 510 calculates the packet propagation delay Δt to the second sensor node 520 by using the secured S(t₁), R(t₂), R(t₃), and S(t₄) and S(t₅), R(t₆), R(t₇), and S(t₈) (S430).

The packet propagation delay Δt between two sensor nodes 510 and 520 can be acquired as follows. First, in a predetermined k-th packet exchange process, a request packet that the first sensor node 510 transmits to the second sensor node 520 is referred to as a request (Q) packet and an answer packet that the second sensor node 520 transmits to the first sensor node 510 is referred to as an ansWer (W) packet. Therefore, S(t₄ₖ) that the first sensor node 510 receives the W packet is defined in Equation 1.

S(t₄ₖ)=S(t₄ₖ₋₃)+Δtₖ+{R(t₄ₖ₋₁)−R(t₄ₖ₋₂)}+Δtₖ [Equation 1]

In the above description, S(t₄ₖ₋₃) and S(t₄ₖ) represent a transmission time of Q packet and a reception time of W packet at the first sensor node 510, respectively. Also, R(t₄ₖ₋₂) and R(t₄ₖ₋₁) represent a reception time of Q packet and a transmission time of W packet at the second sensor node, respectively. A propagation delay Δtₖ represents time of flight (TOF) of the Q packet from the first sensor node 510 to the second sensor node 520 or TOF of the W packet from the second sensor node 520 to the first sensor node 510.

Accordingly, the propagation delay Δtₖ can be acquired as shown in Equation 2 from Equation 1.

Δtₖ=[S(t₄ₖ)−S(t₄ₖ₋₃)−{R(t₄ₖ₋₁)−R(t₄ₖ₋₂)}]/2 [Equation 2]

As described above, in case of the CSMA/CA protocol, two propagation delays Δtₖ can be acquired through two packet exchange processes. Therefore, in this case, the smaller value of two values is determined as the packet transmission time. Meanwhile, in the case of the slotted CSMA/CA protocol, N propagation delays can be acquired through N packet exchange processes. In this case, an average value of N values is determined as the propagation delay. The above description is defined as Equation 3.

$$Δ t = \{ \begin{matrix}\frac{1}{N} {\sum }_{k = 1}^{N} Δ {t}_{k} & for slotted CSMA / CA \\ min ( Δ {t}_{1} , Δ {t}_{2} ) & for CSMA / CA\end{matrix} \qquad [ Equation 3 ]$$

After step S430, the distance estimation unit 360 estimates the distance between two sensor nodes 510 and 520 by using the propagation delay obtained from Equation 3 (S440). An equation for estimating the distance between two sensor nodes 510 and 520 is expressed as Equation 4.

d=Vₚ×Δt [Equation 4]

In the above description, d represents a distance between two sensor nodes and the unit of d is ‘meter’, and Vₚ represents a signal speed (generally, Vₚ=3×10⁸ m/s in wireless communications).

Meanwhile, in the embodiment of the present invention, the second sensor node 520 can estimate the distance to the first sensor node 510. In order to make the function of the second sensor node 520 possible, the second sensor node 520 must receive S(t₁), S(t₄), S(t₅), and S(t₈) from the first sensor node 510. However, this can be easily drawn from FIG. 4 and FIG. 5. Herein, a detailed description thereof will be omitted.

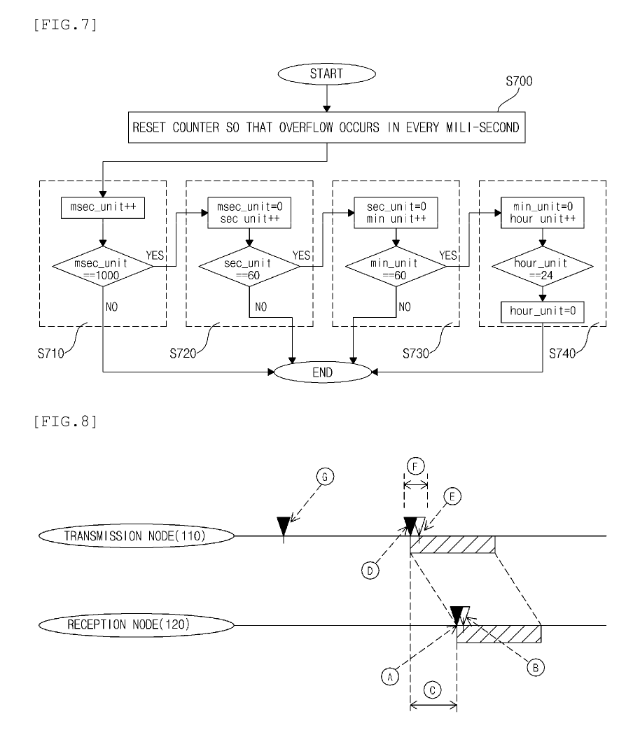

As described above, when a propagation delay is calculated as shown in FIG. 4 and FIG. 5, a distance between two sensor nodes can be estimated. FIG.8 is a diagram illustrating a transmission time and a reception time of a packet by using the present invention; (G) is the moment to attempt to occupy a wireless channel, (D) and (E) denote the moment of transmitting a packet and the moment of actually measuring time referred to a transmission time at a transmission node 110, respectively; (A) and (B) denote the moment of receiving a packet and the moment of actually measuring time referred to a reception time at a reception node 120, respectively.

With the same system performance of both nodes, a time difference (F) between (D) and (E) is identical to a time difference between (A) and (B) because it takes the same processing delay at both nodes in measuring a transmission time and a reception time. Therefore, the effect on errors in time measurement due to the time difference can be negligible. In addition, a transmission node 110 can avoid uncertain delay from (G) to (D) called ‘random back-off’ time in CSMA/CA protocol by actually measuring a transmission time at the moment when the packet transmission is detected. As a result, the present invention can improve the measurement accuracy in a transmission time and a reception time as shown in FIG. 8 unlike the related art.

The spirit of the present invention has been just exemplified. It will be appreciated by those skilled in the art that various modifications, changes, and substitutions can be made without departing from the essential characteristics of the present invention. Accordingly, the disclosed embodiments and accompanying drawings are for not limiting but describing the spirit of the present invention and the scope of the spirit of the present invention is not limited by the embodiments and accompanying drawings. The protection scope of the present invention must be analyzed by the appended claims and it should be analyzed that all spirits within a scope equivalent thereto are included in the appended claims of the present invention.

The present invention can be used in a sensor network, a wireless LAN, etc. and adopted in patient searching in a hospital, missing-child searching, position checking of a harbor container, etc. In particular, since the present invention can accurately grasp the position of a predetermined target without a GPS receiver, the present invention can be more usefully applied to indoor positioning systems to locate people or objects.

What is claimed is:

1. A method for estimating a distance between two nodes in wireless sensor networks, comprising:
(a) measuring a transmission time of a transmission signal transmitted to the other node and a reception time of a reception signal received from the other node in response to the transmission signal, and receiving a reception time of the transmission signal through the reception signal from the other node or a transmission time of the reception signal through a signal received after the reception signal from the other node; and
(b) estimating a distance to the other node by using the transmission/reception time of all signals acquired in step (a).

2. The method according to claim 1, in case that one node transmits a notification signal to the other node for inquiring or providing possessed data and the other node transmits a response signal to reply to the notification signal, wherein step (a) includes:
(aa) measuring a transmission time of the notification signal or a reception time of the response signal at the one node, and receiving a reception time of the notification signal through the response signal from the other node or a transmission time of the response signal through a signal received after the response signal from the other node; or
(aa′) measuring a reception time of the notification signal or a transmission time of the response signal, and receiving the transmission time of the notification signal or the reception time of the response signal from the other node through the signal received after the notification signal.

3. The method according to claim 1, wherein step (a) is repeated at twice to N times to the maximum within a predetermined assigned time so that two nodes exchange data with each other.

4. The method according to claim 2, further comprising:
when step (aa) is repeated twice,
(aa1) transmitting a first signal tapping whether or not it is communicable communication to the other node and measuring a transmission time of the first signal;
(aa2) measuring a reception time of a second signal when receiving the second signal including a reception time of the first signal from the other node and measuring a transmission time of a third signal when transmitting the third signal including sensing data;
(aa3) receiving a fourth signal including a transmission time of the second signal and a reception time of the third signal from the other node; and
(aa4) receiving a fifth signal including a transmission time of the fourth signal from the other node.

5. The method according to claim 2, further comprising:
when step (aa′) is repeated twice,
(aa′1) measuring the reception time of the first signal when receiving the first signal tapping whether or not it is communicable communication from the other node;
(aa′2) measuring the transmission time of the second signal while transmitting the second signal responding to the first signal to the other node;
(aa′3) measuring the reception time of the third signal when receiving the third signal including the transmission time of the first signal and the reception time of the second signal from the other node;
(aa′4) measuring the transmission time of the fourth signal while transmitting the fourth signal including a request for the transmission time of the third signal to the other node; and
(aa′5) receiving a signal including the transmission time of the third signal and the reception time of the fourth signal from the other node.

6. The method according to claim 1, wherein step (b) includes:
(ba) calculating a propagation delay of a signal to the other node by using the transmission/reception time of all the signals acquired in step (a); and
(bb) estimating a distance to the other node by using the calculated propagation delay of the signal.

7. The method according to claim 6, wherein in step (ba), the propagation delay of the signal is calculated by using the following equation.
Δtₖ=[S(t₄ₖ)−S(t₄ₖ₋₃)−{R(t₄ₖ₋₁)−R(t₄ₖ₋₂)}]/2 [Equation]
where, Δtₖ represents the propagation delay of the signal, S(t₄ₖ) the reception time of the response signal, S(t₄ₖ₋₃) represents the transmission time of the notification signal, R(t₄ₖ₋₂) represents the reception time of the notification signal of the other node, and R(t₄ₖ₋₁) represents the transmission time of the response signal of the other node.

8. The method according to claim 6, wherein when the number of propagation delays calculated through step (ba) is 2, the smaller value of them is determined as the propagation delay to the other node and when the number of propagation delays calculated through step (ba) is 3 or more, an average value of them is determined as the propagation delay to the other node.

9. The method according to claim 6, wherein in step (bb), the distance to the other node is detected by using the following equation.
d=Vₚ×Δtₖ=Vₚ×[[S(t₄ₖ)−S(t₄ₖ₋₃)−{R(t₄ₖ₋₁)−R(t₄ₖ₋₂)}]/2] [Equation]
where, d represents the distance to the other node, Vₚ represents a transmission speed of a packet, Δtₖ represents the propagation delay, S(t₄ₖ) represents the reception time of the response signal, S(t₄ₖ₋₃) represents the transmission time of the notification signal, R(t₄ₖ₋₂) represents the reception time of the notification signal of the other node, and R(t₄ₖ₋₁) represents the transmission time of the response signal of the other node.

10. The method according to claim 1, wherein a system for estimating a distance between nodes in a wireless sensor network includes:
a counter that has a time resolution function; and
a register that stores a counting value indicated by the counter, and
wherein in step (a), the transmission time or the reception time is measured by adding up a drawn value (V) from the following equation in the control unit and the counting value stored in the register.
V=msec_unit+1000×{sec_unit+60×(min_unit+60×hour_unit)} [Equation]
where, msec_unit represents a value of a mili-second unit, sec_unit represents a value of a second unit, min_unit represents a value of a minute unit, and hour_unit represents a value of a hour unit.

11. The method according to claim 10, wherein step (a) includes initializing the corresponding-unit value to 0 when the measured value under the second unit is 1000, the measured second-unit value or the measured minute-unit value is 60, or the measured hour-unit value 24.

12. A system for estimating a distance between nodes in wireless sensor networks, comprising:
a sensing node that measures a transmission time of a transmission signal transmitted to the other node and a reception time of a reception signal received from the other node in response to the transmission signal and receives a reception time of the transmission signal through the reception signal and a transmission time of the reception signal through a signal received after the reception signal from the other node.

13. The system according to claim 12, wherein the sensing node is a node for inquiring or providing possessed data or for being inquired or receiving the data.

14. The system according to claim 12, wherein the sensing node receives the reception time of the transmission signal and the transmission time of the reception signal from the other node at twice to N times to the maximum within a predetermined assigned time so that two nodes exchange data with each other.

15. The system according to claim 12, wherein the sensing node calculates a propagation delay to the other node by using the transmission/reception time of all the acquired signals and estimates a distance to the other node by using the calculated propagation delay.

16. The system according to claim 15, wherein when the number of calculated propagation delays is 2, the sensing node determines the smaller value of them as the propagation delay to the other node and when the number of calculated propagation delays is 3 or more, the sensing node determines an average value of them as the propagation delay to the other node.

17. The system according to claim 15, wherein the sensing node estimates a distance to the other node by using the following equation.
d=Vₚ×Δtₖ=Vₚ×[[S(t₄ₖ)−S(t₄ₖ₋₃)−{R(t₄ₖ₋₁)−R(t₄ₖ₋₂)}]/2] [Equation]
where, d represents the distance to the other node, Vₚ represents a transmission speed of a packet, Δtₖ represents the propagation delay, S(t₄ₖ) represents the reception time of the response signal, S(t₄ₖ₋₃) represents the transmission time of the notification signal, R(t₄ₖ₋₂) represents the reception time of the notification signal of the other node, and R(t₄ₖ₋₁) represents the transmission time of the response signal of the other node.

18. The system according to claim 12, wherein the sensing node includes:
a time measurement unit that measures the transmission time of the transmission signal transmitted to the other node and the reception time of the reception signal received from the other node in response to the transmission signal; and
a distance estimation unit that estimates the distance to the other node by using the propagation delay calculated with the transmission time and the reception time of all signals.

19. The system according to claim 18, wherein when a signal detection unit that detects the transmission signal or the reception signal applies a detection signal, the time measurement unit measures a generation time of the applied signal.

20. The system according to claim 18, wherein the time measurement unit includes:
a counter that has a time resolution function; and
a register that stores a counting value indicated by the counter, and
wherein the transmission time or the reception time is measured by adding up a drawn value (V) from the following equation in the control unit and the counting value stored in the register.
V=msec_unit+1000×{sec_unit+60×(min_unit+60×hour_unit)} [Equation]
where, msec_unit represents a value of a mili-second unit, sec_unit represents a value of a second unit, min_unit represents a value of a minute unit, and hour_unit represents a value of a hour unit.
